(19) United States
(12) Patent Application Publication
(10) Pub. No.: US 2025/0379387 A1
(43) Pub. Date: Dec. 11, 2025

(54) ELECTRICAL CONNECTOR

(71) Applicant: Molex, LLC, Lisle, IL (US)

(72) Inventor: Yun-Fang Yang, Shanghai (CN)

(21) Appl. No.: 19/234,319

(22) Filed: Jun. 11, 2025

(30) Foreign Application Priority Data
Jun. 11, 2024 (CN) 202410749364.3

(51) Int. Cl. H01R 13/42; H01R 13/52

(52) U.S. Cl. CPC H01R 13/42; H01R 13/5205

(57) ABSTRACT

An electrical connector is provided. The electrical connector includes: a housing; at least two first conductive terminals which are inserted into the housing; at least one pair of first wires which are electrically connected to the first conductive terminal; at least one group of second conductive terminal which is inserted into the housing; at least one second wire which is electrically connected to the second conductive terminal; wherein, the first conductive terminal is adjacent to the second conductive terminal in a first direction; the housing includes a first side and a second side which are perpendicular to a second direction, the first direction intersects the second direction; in each pair of first wires, the two first wires respectively exit from the first side and the second side of the housing; the at least one second wire exits from at least one side of the housing along the second direction. The electrical connector effectively utilizes an interval and a space, and is beneficial to meet miniaturization requirement of a device.

### TECHNICAL FIELD

The present disclosure relates to the field of electrical engineering technology, and specifically relates to an electrical connector.

### BACKGROUND

An electrical connector is an element which is used to bridge two conductors in one circuitry so that a current or a signal may flow from one conductor to the other conductor. In modern electronic devices, the requirements for the electrical connector become higher and higher, the electrical connector needs that a dimension is reduced to be as small as possible while performance is assured, so as to meet the trends of weight-lightening, thinning and miniaturization of the device.

In the modern electronic devices, some application scenes require the electrical connector to be capable of realizing that wires exit from multiple directions. However, in traditional electrical connectors, a terminal is only connected to one contact point on one wire/cable or printed circuit board (PCB), an arrangement manner of the terminals is not beneficial to a layout in a limited space, and cannot meet the requirements for multi-direction and multi-path connection.

It should be noted that, the information disclosed in the background is only for enhancing the understanding of the background of the present disclosure, and therefore may include information that does not constitute the prior art known to those of ordinary skill in the art.

### SUMMARY

In view of the above, an aspect of the present disclosure provides an electrical connector, comprising: a housing which comprises a first side and a second side opposite to the first side; at least two first conductive terminals which are inserted into the housing, each first conductive terminal is electrically connected to at least two corresponding first wires; at least one group of second conductive terminal which are inserted into the housing, each second conductive terminal of each group of second conductive terminal is electrically connected to at least one corresponding second wire; wherein, each group of second conductive terminal is adjacent to at least one first conductive terminal in a first direction, one part of the first wires which are electrically connected correspondingly to each first conductive terminal exits from the first side of the housing, the other part of the first wires which are electrically connected correspondingly to each first conductive terminal exits from the housing of the second side; the at least one second wire which is electrically connected correspondingly to each second conductive terminal exits from at least one side of the housing.

In some embodiments, that each second conductive terminal is electrically connected to at least one corresponding second wire comprises that each second conductive terminal is electrically connected to at least two corresponding second wires; wherein, a part of the second wires which are electrically connected correspondingly to each second conductive terminal exits from the first side of the housing, the other part of the second wires which are electrically connected correspondingly to each second conductive terminal exits from the second side of the housing.

In some embodiments, the second wires that exit from the first side of the housing form a second wire group, the second wires in the second wire group are distributed as N row(s) and m column(s), where, N and M each are an integer which is larger than or equal to 1.

In some embodiments, each group of second conductive terminal is distributed as the second conductive terminals of A column(s) and B row(s), each column extends along a second direction, each row extends along the first direction, wherein the second direction intersects the first direction, A and B each are an integer which is larger than or equal to 1; an extending width of at least one first conductive terminal in the second direction is not less than a distance between centers of any two second conductive terminals of each column of each group of second conductive terminal.

In some embodiments, the first side and the second side are long sides of the housing.

In some embodiments, the housing comprises: a base having a top surface and a bottom surface which are opposite to each other and side surfaces which extend between the top surface and the bottom surface; and a front mating portion which extends from the top surface of the base toward a direction away from the bottom surface.

In some embodiments, the housing further comprises: a receiving cavity extending along a direction from the bottom surface of the base to the top surface; the electrical connector further comprises: a wire sealing component which is provided in the receiving cavity and is close to the top surface, the first conductive terminal and the second conductive terminal are inserted into the wire sealing component to make a part of the first conductive terminal and a part of the second conductive terminal positioned in the receiving cavity; and a sealing body which is used to seal the receiving cavity.

In some embodiments, the wire sealing component comprises at least two cover plates, with an interval provided between the two adjacent cover plates; the first conductive terminal is inserted into the cover plate, and each group of second conductive terminal is inserted into the interval between the two adjacent cover plates.

In some embodiments, the housing further comprises: a sealing ring sheathing an outer periphery of a side of the front mating portion which is away from the base.

In some embodiments, the second wire is electrically connected to the second conductive terminal via a printed circuit board.

Another aspect of the present disclosure provides an electrical connector, comprising: a housing comprising a first side and a second side which is opposite to the first side; at least two first conductive terminals which are inserted into the housing, each first conductive terminal is electrically connected to at least one corresponding first wire; at least one group of second conductive terminal which is inserted into the housing, each second conductive terminal of each group of second conductive terminal is electrically connected to at least two corresponding second wires; wherein, each group of second conductive terminal is adjacent to at least one first conductive terminal in a first direction, the at least one first wire which is electrically connected correspondingly to each first conductive terminal exits from at least one side of the housing, one part of the second wires which are electrically connected correspondingly to each second conductive terminal exits from the first side of the housing, the other part of the second wires which are electrically connected correspondingly to each second conductive terminal exits from the second side of the housing.

The electrical connector provided by the present disclosure may/at least has following advantages: the embodiments of the present disclosure optimize an arrangement manner of the first conductive terminals and the second conductive terminals, by that the first conductive terminal and the second conductive terminals are adjacently arranged in the first direction, a gap between the adjacent first conductive terminals is effectively utilized, a layout of each conductive terminal is more compact, so that space utilization is promoted. By that one part of the first wires which are electrically connected correspondingly to each first conductive terminal exits from the first side of the housing, the other part of the first wires which are electrically connected correspondingly to each first conductive terminal exits from the second side of the housing, the first conductive terminal is capable of making the first wires exit from multiple directions, the requirements for multi-direction and multi-path connection are met. At the same time, that the wires from the aforementioned different directions are integrated in the same electrical connector is beneficial to accommodate an application requirement in a limited space.

### BRIEF DESCRIPTION OF THE DRAWINGS

Other features, objects, and advantages of the present disclosure will become more apparent by reading the detailed description of non-limiting embodiments with reference to the accompanying drawings.

FIG. 1 is an exploded view of an electrical connector provided by some embodiments of the present disclosure;

FIG. 2 and FIG. 3 are perspective structure schematic views of first conductive terminals, first wires, second conductive terminals, second wires, a printed circuit board and wire clamps in the electrical connector provided by some embodiments of the present disclosure;

FIG. 4 and FIG. 5 are perspective structure schematic views of the second conductive terminals, the second wires, the printed circuit board and the wire clamps in the electrical connector provided by some embodiments of the present disclosure;

FIG. 6 and FIG. 7 are perspective structure schematic views of the electrical connector provided by some embodiments of the present disclosure with a sealing body omitted;

FIG. 8 is a perspective structure schematic view of a wire sealing component in the electrical connector provided by some embodiments of the present disclosure;

FIG. 9 is a perspective structure schematic view of the first conductive terminals, the first wires, the second conductive terminals, the second wires, the printed circuit board and the wire sealing component in the electrical connector provided by some embodiments of the present disclosure;

FIG. 10 is a side view of FIG. 9;

FIG. 11 is a bottom view of a housing in the electrical connector provided by some embodiments of the present disclosure with the wire sealing component being not mounted in the housing;

FIG. 12 is a bottom view of the housing in the electrical connector provided by some embodiments of the present disclosure with the wire sealing component mounted in the housing;

FIG. 13 is a perspective structure schematic view of a wire sealing component in an electrical connector provided by other embodiments of the present disclosure;

FIG. 14 is a bottom view of the electrical connector provided by other embodiments of the present disclosure with the sealing body omitted;

FIG. 15 is a bottom view of the housing in the electrical connector provided by other embodiments of the present disclosure with the wire sealing component being not mounted in the housing;

FIG. 16 is a bottom view of the housing in the electrical connector provided by other embodiments of the present disclosure with the wire sealing component mounted in the housing;

FIG. 17 is an exploded view of the electrical connector provided by other embodiments of the present disclosure.

### DETAILED DESCRIPTION

In order to facilitate understanding of the present disclosure, the present disclosure will be more comprehensively described below with reference to the relevant drawings. Preferred embodiments of the present disclosure are shown in the drawings. However, the present disclosure can be implemented in many different forms and is not limited to the embodiments described herein. On the contrary, a purpose of providing these embodiments is to make the disclosed content of the present disclosure more thorough and comprehensive.

Unless otherwise defined, all technical and scientific terms used herein have the same meanings as those commonly understood by those skilled in the art belonging to the present disclosure. The terms used in the specification of the present disclosure are only for the purpose of describing specific embodiments and are not intended to limit the present disclosure.

It should be understood that, although the terms first, second, third, and the like may be used to describe various elements, components, regions, layers, doping types, and/or portions, these elements, components, regions, layers, doping types, and/or portions should not be limited by these terms. These terms are only used to distinguish one element, component, region, layer, doping type or portion from another element, component, region, layer, doping type or portion. Therefore, without departing from the teachings of the present disclosure, the first element, component, region, layer, doping type, or portion discussed below may be referred to as a second element, component, region, layer, or portion; For example, a first wire may be referred to as a second wire, and similarly, the second wire may be referred to as the first wire; The first wire and the second wire are different wires, for example, the first wire may be a power line and the second wire can be a signal line, or the first wire may be a signal line and the second wire may be a power line.

Although the terms “front”, “back”, “between”, etc. may be used in this specification to describe different exemplary features and elements of the present disclosure, these terms are used only for convenience herein, for example, depends on the direction of the examples in the drawings. Any content in this specification should be understood as requiring a specific three-dimensional orientation of the structure to fall within the scope of the present disclosure. And the illustrations provided in the embodiments only illustrate the basic concept of the present disclosure in a schematic manner. Although the illustrations only show the components related to the present disclosure and are not drawn according to the actual number, shape, and size of the components during implementation, the form, number, and proportion of each component during actual implementation can be arbitrarily changed, and the layout of the components may also be more complex.

When used herein, singular forms of “a/an”, “one”, and “the” may also include plural forms, unless the context clearly indicates other forms. It should also be understood that, when the terms “consist of” and/or “include/comprise” are used in this specification, it may be determined the presence of the described feature, integer, element, and/or component, but the presence or addition of one or more other features, integers, elements, components, and/or groups is not excluded. Meanwhile, when used herein, the term “and/or” includes any and all combinations of the listed items.

An electrical connector is an element which is used to bridge two conductors in one circuitry so that a current or a signal may flow from one conductor to the other conductor. In modern electronic devices, the requirements for the electrical connector become higher and higher, the electrical connector needs that a dimension is reduced to be as small as possible while performance is assured, so as to meet the trends of weight-lightening, thinning and miniaturization of the device.

In view of the above, the present disclosure provides an electrical connector which is beneficial to meet miniaturization requirement of a device. A detailed content of the electrical connector will be described in subsequent embodiments.

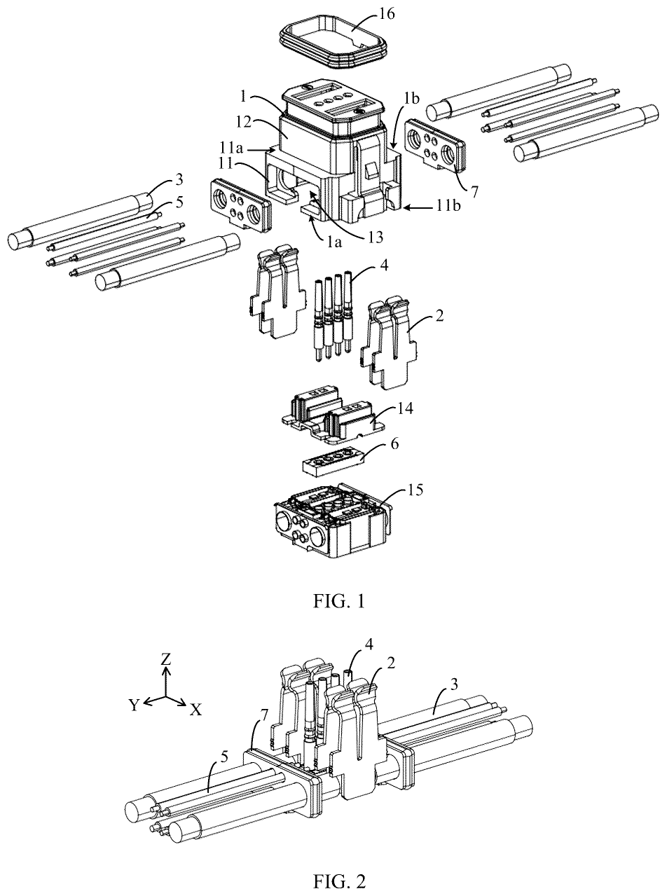

Referring to FIG. 1, an electrical connector provided by the present disclosure specifically may include a housing 1, at least two first conductive terminals 2 and at least one group of second conductive terminal 4.

As shown in FIG. 1, the housing 1 may include a first side 1a and a second side 1b opposite to the first side 1a.

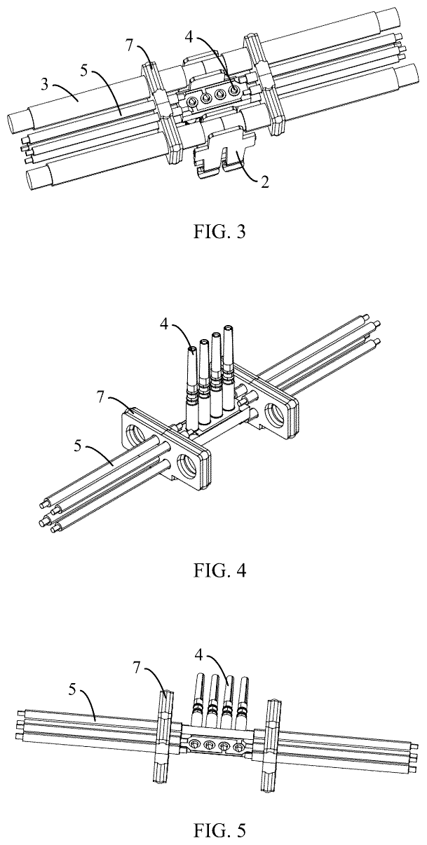

The first conductive terminals 2 may be inserted into the housing 1. As shown in FIG. 2 and FIG. 3, each first conductive terminal 2 are electrically connected to at least two corresponding first wires 3.

The second conductive terminals 4 may be inserted into the housing 1. As shown in FIG. 4 and FIG. 5, each second conductive terminal 4 of each group of second conductive terminal 4 is electrically connected to at least one corresponding second wire 5.

For sake of convenient description, in embodiments of the present disclosure, each first conductive terminal 2 is electrically connected to the two first wires 3, each second conductive terminal 4 is electrically connected to the two second wires 5.

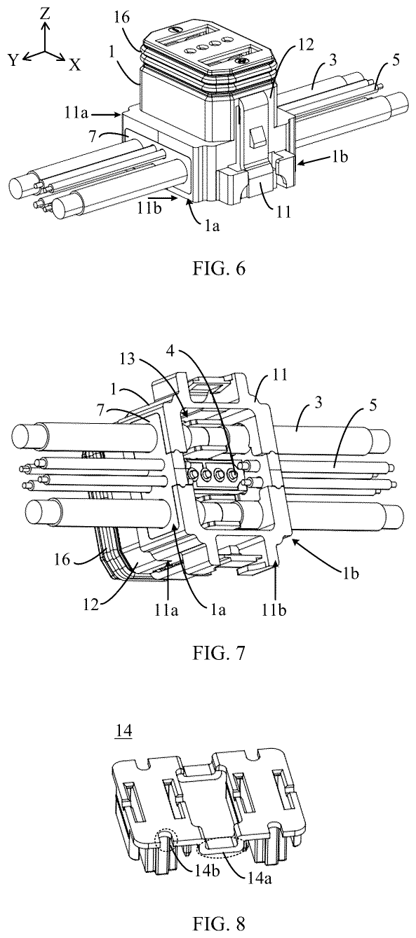

As shown in FIG. 2, each group of second conductive terminal 4 is adjacent to at least one first conductive terminal 2 in a first direction. And, as shown in FIG. 6 and FIG. 7, one part of the first wires 3 which are electrically connected correspondingly to each first conductive terminal 2 may exit from the first side 1a of the housing 1, the other part of the first wires 3 which are electrically connected correspondingly to each first conductive terminal 2 may exit from the second side 1b of the housing 1; the second wires 5 which are electrically connected correspondingly to each second conductive terminal 4 may exit from at least one side of the housing 1.

Exemplarily, one second wire 5 of each pair of the second wires 5 which correspond to each second conductive terminal 4 exits from the first side 1a of the housing 1, the other second wire 5 of each pair of the second wires 5 which correspond to each second conductive terminal 4 exits from the second side 1b of the housing 1. In other embodiments, in a condition that an entire dimension and a performance of the electrical connector are not affected, each second wire 5 which corresponds to each second conductive terminal 4 may exit from one side of the electrical connector, or one part of the second wires 5 which correspond to each second conductive terminal 4 exits from one side of the electrical connector, the other part of the second wires 5 which correspond to each second conductive terminal 4 exits from the other side of the electrical connector, which may be determined according to practical application requirement. For example, a group of second conductive terminal 4 has the two second conductive terminals 4, each second conductive terminal 4 is electrically connected correspondingly to the three second wires 5, the three second wires 5 corresponding to one second conductive terminal 4 may exit from the first side 1a of the housing 1, the three second wires 5 corresponding to the other second conductive terminal 4 may exit from the second side 1b of the housing 1; or, one second wire 5 of one second conductive terminal 4 exits from the first side 1a of the housing 1, the other two second wires 5 of the one second conductive terminal 4 exit from the second side 1b of the housing 1, one second wire 5 of the other second conductive terminal 4 exits from the second side 1b of the housing 1, the other two second wires 5 of the other second conductive terminal 4 exit from the first side 1a of the housing 1.

The embodiments of the present disclosure optimize an arrangement manner of the first conductive terminals 2 and the second conductive terminals 4, by that the first conductive terminal 2 and the second conductive terminals 4 are adjacently arranged in the first direction, a gap between the adjacent first conductive terminals 2 is effectively utilized, a layout of each conductive terminal is more compact, so that space utilization is promoted. By that one part of the first wires 3 which are electrically connected correspondingly to each first conductive terminal 2 exits from the first side 1a of the housing 1, the other part of the first wires 3 which are electrically connected correspondingly to each first conductive terminal 2 exits from the second side 1b of the housing 1, the first conductive terminal 2 is capable of making the first wires 3 exit from multiple directions, the requirements for multi-direction and multi-path connection are met. At the same time, that the wires from the aforementioned different directions are integrated in the same electrical connector is beneficial to accommodate an application requirement in a limited space.

For example, as shown in FIG. 2 to FIG. 5, the electrical connector is provided with the two first conductive terminals 2 and the four second conductive terminals 4. Where, it may define that the four second conductive terminals 4 are a group of second conductive terminal 4.

It may be understood that a group of second conductive terminal 4 may include one second conductive terminal 4, also may include a plurality of second conductive terminals 4, the specific number of the second conductive terminal 4 is determined according to practical situation.

As an example, the electrical connector also may be provided with the three first conductive terminals 2 and the two groups of second conductive terminals 4, which are sequentially arranged as one first conductive terminal 2, one group of second conductive terminal 4, one first conductive terminal 2, one group of second conductive terminal 4 and one first conductive terminal 2.

Exemplarily, the first conductive terminal 2 may include a power terminal which is adapted to carry high current (for example a current of 35 A, also may be other higher current). In high current transmission, an interval between the adjacent power terminals needs to be sufficiently large, so as to avoid arc discharge phenomenon occurring when a high current instantly flows through. That a group of second conductive terminal 4 is placed between the two adjacent first conductive terminals 2 may sufficiently utilize the interval between the adjacent first conductive terminals 2, the layout of the conductive terminals is more compact, it is beneficial to reduce a space occupied by the electrical connector, so as to realize a design of the electrical connector under the requirement of a small dimension and a high current.

As an example, the second conductive terminal 4 may include a signal terminal which carries a lower current (for example a current of 3 A-5 A, also may be other lower current).

Embodiments of the present disclosure do not have specific limit on a form of the first conductive terminal 2 and a form of the second conductive terminal 4. As an example, the first conductive terminal 2 may be a plate-shaped elastic terminal, which has a simple manufacturing process, is suitable for mass production, and is lower in cost; the second conductive terminals 4 may be a cylinder elastic terminal. As shown in FIG. 2, each group of cylinder elastic terminals, which are arranged to be spaced apart from each other, can be inserted between two adjacent plate-shaped elastic terminals, so that the layout of the conductive terminals is more compact, and space is effectively saved.

It may be understood that, in some embodiments, each second conductive terminal 4 may be electrically connected correspondingly to one second wire 5.

In other embodiments, each second conductive terminal 4 also may be electrically connected correspondingly to at least two second wires 5. Wherein, one part of the second wires 5 which are electrically connected correspondingly to each second conductive terminal 4 may exit from the first side 1a of the housing 1, the other part of the second wires 5 which are electrically connected correspondingly to each second conductive terminal 4 may exit from the second side 1b of the housing 1.

In the above embodiments, by that one part of the second wires 5 which are electrically connected correspondingly to each second conductive terminal 4 exits from the first side 1a of the housing 1, the other part of the second wires 5 which are electrically connected correspondingly to each second conductive terminal 4 exits from the second side 1b of the housing 1, the second conductive terminal 4 also is capable of making the second wires 5 exit from multiple directions, the requirements for multi-direction and multi-path connection are met, a connecting direction of the electrical connector is further expanded, the electrical connector is capable of provide more flexible options of wiring, it is helpful for the electrical connector to accommodate different circuit layout requirements. This is also helpful to simplify the design and mounting process of wiring in an interior of a device.

As an example, as shown in FIG. 6, the first side 1a and the second side 1b may be positioned respectively at long sides of the housing 1. Because the long side has more space for wire arrangement compared to the short side, the electrical connector has more room for wire arrangement while a dimension of the electrical connector may be not affected, a wire layout is more compact, so that the space occupied by the electrical connector is saved, the entire dimension of the electrical connector is smaller, the electrical connector is adapted to a device layout in a limited space.

For sake of convenient description, a plurality of second wires 5 exit from the first side 1a or the second side 1b of the housing 1 may be defined as a second wire group. In some embodiments, the plurality of second wires 5 in the second wire group may be distributed as N row(s) and M column(s). Where, N and M each are an integer which is larger than or equal to 1.

It may be understood that the present disclosure does not have specific limit on an arrangement manner of the plurality of second wires 5 of the second wire group, the arrangement manner of the plurality of second wires 5 of the second wire group may be adaptively set according to a practical application requirement.

For example, the electrical connector as shown in FIG. 7 takes the four second wires 5, which exits from the first side 1a of the housing 1, as a second wire group, the four second wires 5 in the second wire group are distributed as two rows and two columns.

In the above embodiments, that the plurality of second wires 5 in the second wire group are distributed as N row(s) may sufficiently utilize a longitudinal space of the housing 1; that the plurality of second wires 5 in the second wire group are distributed as M column(s) may sufficiently utilize a transverse space of the housing 1.

In some embodiments, the second conductive terminals 4 in each group of second conductive terminal 4 may be distributed as A column(s) and B row(s), where each column extends along a second direction, each row extends along the first direction; where, A and B each are an integer which is larger than or equal to 1.

The first direction and the second direction associated to the embodiments of the present disclosure intersect each other. Exemplarily, the second direction may be perpendicular to the first direction. For sake of convenient understanding, exemplary description is performed by taking X direction depicted in the drawings as the first direction and taking Y direction as the second direction.

In the above embodiments, an extending width of at least one first conductive terminal 2 in the second direction is not less than a distance between centers of any two second conductive terminals 4 in each column of each group of second conductive terminal 4.

Embodiments of the present disclosure do not have specific limit on a material of the housing 1. As an example, the housing 1 may include but may be not limited to a plastic housing.

Continuously referring to FIG. 1, FIG. 6 and FIG. 7, in some embodiments, the housing 1 specifically may include a base 11 and a front mating portion 12.

The base 11 has a top surface 11a and a bottom surface 11b which are opposite to each other, and side surfaces which extend between the top surface 11a and the bottom surface 11b.

The front mating portion 12 extends from the top surface 11a of the base 11 toward a direction away from the bottom surface 11b.

It may be understood that, as shown in FIG. 6, the side surfaces of the base 11 may include a first surface (not labeled) which is positioned at the first side 1a of the housing 1, a second surface (not labeled) which is positioned at the second side 1b of the housing 1, and a third surface (not labeled) and a fourth surface (not labeled) which are perpendicular to the first surface.

In some embodiments, the housing 1 may further include a receiving cavity 13; the electrical connector may further include a wire sealing component 14.

Specifically, the receiving cavity 13 extends along a direction from the bottom surface 11b of the base 11 to the top surface 11a, may receive a part of the first conductive terminal 2 and a part of the second conductive terminal 4.

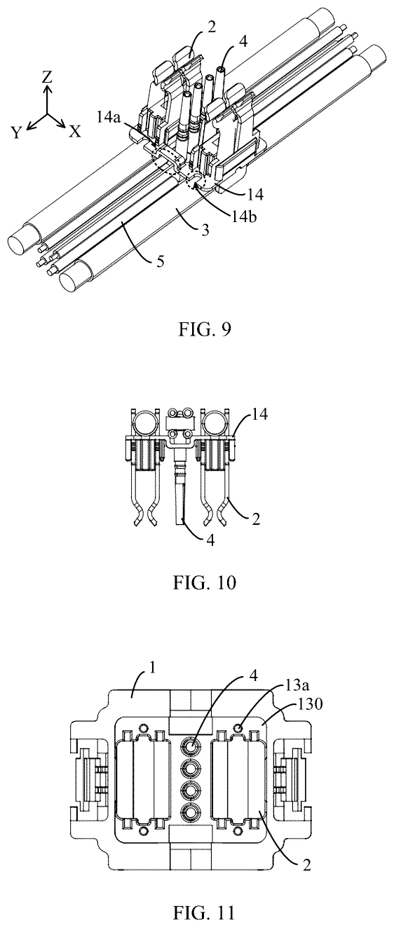

A structure of the wire sealing component 14 may be for example that as shown in FIG. 8. As shown in FIG. 9 to FIG. 12, a position in the receiving cavity 13 close to the top surface 11a may be provided with a mounting face 130. The wire sealing component 14 is provided on the mounting face 130 in the receiving cavity 13; the first conductive terminals 2 and the second conductive terminals 4 are inserted into the wire sealing component 14, so that a part of the first conductive terminal 2 and a part of the second conductive terminal 4 are positioned in the receiving cavity 13.

Exemplarily, the mounting face 130 of the receiving cavity 13 may be provided thereon with a guiding post 13a to facilitate fitting and positioning of the wire sealing component 14 with the mounting face 130, which will be described later in detail.

The embodiments of the present disclosure do not have specific limit on a material of the wire sealing component 14. As an example, the wire sealing component 14 may include but may be not limited to a plastic sealing component.

As shown in FIG. 1, the housing 1 may further include a sealing body 15 which is used to seal the receiving cavity 13.

As an example, in the receiving cavity 13, the wire sealing component 14, the side surfaces of the base 11 and wire clamps 7 which are respectively mounted to the side surfaces of the base 11 may together constitute a potting space. The potting space may be used to accommodate the filling of the sealing body 15, allowing the bottom surface 11b of the base 11 to achieve sealing through the sealing body 15.

Embodiments of the present disclosure do not have specific limit on a form of the sealing body 15. As an example, a sealant may be potted into a space between the wire sealing component 14 and an opening of the bottom surface 11b from the bottom surface 11b of the base 11, to achieve back sealing of the electrical connector.

The sealing body 15 formed by using potting the sealant may effectively prevent external substance, such as water and/or dust and the like, from entering into the interior of the electrical connector, so that waterproof and dustproof performance of the electrical connector is promoted. This is important for the electrical connector to be applied in a severe circumstance, and is beneficial to ensure stability and reliability of the electrical connector. And, the sealing body 15 formed by potting is further capable of better adherently fixing the wires 3, 5 and the conductive terminals 2, 4 together, so that a retention force between the wires 3, 5 and the corresponding conductive terminals 2, 4 is promoted, possibility of becoming loose or detaching of the wires 3, 5 due to external vibration or impact is reduced, robustness of the electrical connector is enhanced, so that failure risk of the electrical connector due to mechanical damage is reduced, durability of the electrical connector is promoted, problems of contact poor and circuit interrupt due to loosening is reduced.

In some embodiments, the wire sealing component 14 may be a structure which is integrally formed, as shown in FIG. 8, and is provided with a first depressed portion 14a; as shown in FIG. 9, the first depressed portion 14a may be used to provide an avoiding space for the second wires 5.

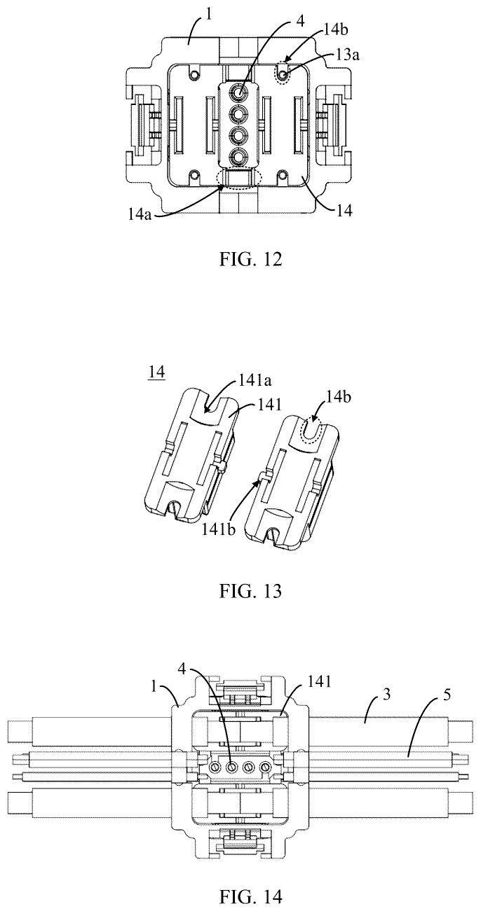

In some embodiments, the wire sealing component 14 may be further provided with a positioning notch 14b which is used to cooperate with the guiding post 13a. When the wire sealing component 14 is mounted, as shown in FIG. 12, the positioning notch 14b is aligned with the guiding post 13a on the mounting face 130 to make the wire sealing component 14 and the mounting face 130 of the receiving cavity 13 form cooperation, mounting of the wire sealing component 14 may be completed.

In other embodiments, as shown in FIG. 13, the wire sealing component 14 may include at least two cover plates 141, the two adjacent cover plates 141 have an interval therebetween.

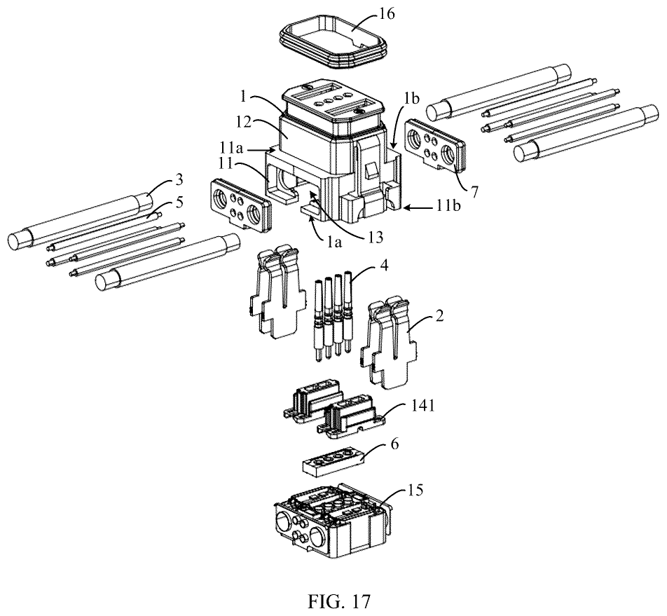

In the above embodiments, as shown in FIG. 14 to FIG. 17, the first conductive terminals 2 may be inserted into the cover plates 141 respectively, each group of second conductive terminal 4 may be inserted into the interval between the two adjacent cover plates 141.

As an example, as shown in FIG. 13, the cover plate 141 may be provided with a second depressed portion 141a which provides an avoiding space for the first wires 3.

As shown in FIG. 13, the wire sealing component 14 of the above embodiments also may be provided with the positioning notch 14b which is used to cooperate with the guiding post 13a. When the wire sealing component 14 is mounted, as shown in FIG. 12, the positioning notches 14b are aligned with the guiding posts 13a on the mounting face 130 respectively to make the wire sealing component 14 and the mounting face 130 of the receiving cavity 13 form cooperation, mounting of the wire sealing component 14 may be completed.

Exemplarily, the above embodiments of the wire sealing component 14 may be further provided with cooperating portions 141b.

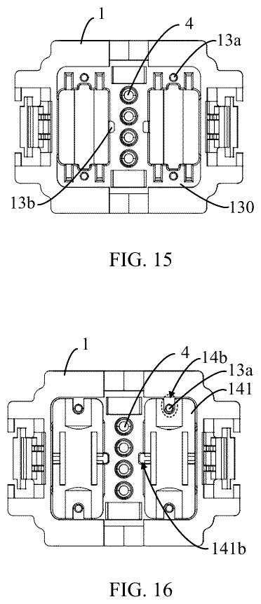

In some embodiments, the mounting face 130 of the receiving cavity 13 may be further provided with recessed grooves 13b. When the wire sealing component 14 is mounted, as shown in FIG. 15 and FIG. 16, the cooperating portions 141b of the wire sealing component 14 are respectively aligned with the recessed grooves 13b on the mounting face 130 to make the wire sealing component 14 and the mounting face 130 of the receiving cavity 13 form cooperation, mounting of the wire sealing component 14 may be completed.

Exemplarily, the cooperating portion 141b may be formed as a protrusion which is used to cooperate with the recessed groove 13b.

In some embodiments, the sealing body 15 may be further used to seal a first soldered region between the first conductive terminal 2 and the first wire 3 and a second soldered region between the second conductive terminal 4 and the second wire 5.

By using that the sealing body 15 seals the first soldered region and the second soldered region, the wires 3, 5 and the conductive terminal 2, 4 are better adherently fixed together, so that a retention force between the wires 3, 5 and the corresponding conductive terminals 2, 4 is promoted, possibility of becoming loose or detaching of the wires 3, 5 due to external vibration or impact is reduced, robustness of the electrical connector is enhanced.

Embodiments of the present disclosure do not have specific limit on a manner of realizing electrical connection between the second wire 5 and the second conductive terminal 4. In some embodiments, as shown in FIG. 1, the second wire 5 and the second conductive terminal 4 may realize electrical connection via a printed circuit board (PCB) 6. The printed circuit board 6 may be designed with different conductive paths thereon to function as wires between the second wires 5 and the second conductive terminals 4, so as to facilitate routing in a limited space.

As an example, a plurality of second wires 55 pass through corresponding penetrating holes in the wire clamps 7, are respectively soldered on edge pads of the printed circuit board 6, and the corresponding second conductive terminals 4 directly electrically connected to through holes in a middle of the printed circuit board 6 respectively, by a conductive path between each through hole and each edge pad, electrical connection between the second wire 5 and the second conductive terminal 4 is realized, mounting is convenient, and an occupied space is smaller.

Exemplarily, the first wire 3 may be directly soldered to the first conductive terminal 2, but the present disclosure is not limited thereto.

It may be understood that, in the embodiments of the present disclosure, the first soldered region between the first conductive terminals 2 and the first wire 3 and the second soldered region between the second conductive terminal 4 and the second wire 5 are positioned in the interior of the electrical connector.

Continuously referring to FIG. 6 and FIG. 7, in some embodiments, the housing 1 may further include a sealing ring 16. The sealing ring 16 sheathes an outer periphery of a side of the front mating portion 12 which is away from the base 11.

When the electrical connector provided by the above embodiments mates with another electrical connector which matches with the electrical connector, the sealing ring 16 may be used to realize sealing between the electrical connector and the another electrical connector, prevent an external liquid (for example water), a gas (for example moisture) and a particle (for example dust) from entering into the interior of the electrical connector. And, the sealing ring 16 provides additional mechanical support when the electrical connector mates with the another electrical connector, is capable of absorbing a certain shock and impact, prevent the electrical connector and the another electrical connector which matches with the electrical connector from becoming loose or detaching during use, and is beneficial to promote stability and use reliability of the electrical connector.

As shown in FIG. 6 and FIG. 7, wire connecting ports of the electrical connector may be provided with the wire clamps 7 which are used to fix and protect the first wires 3 and the second wires 5, ensure the first wire 3 and the second wire 5 to be firmly connected to the corresponding conductive terminals. Exemplarily, the wire clamp 7 may made of a rubber, be provided with penetrating holes, diameters of the penetrating holes are slightly less than diameters of the respective wires 3, 5 according to the diameters of the respective wires 3, 5, each wire 3, 5 passes through the corresponding penetrating hole, inner sides of the penetrating holes of the wire clamp 7 may interfere with the first wires 3 and the second wires 5 respectively, so as to realize wire end sealing; a surface of the wire clamp 7 which contacts the housing 1 is provided with a protrusion, when the wire clamp 7 is mounted, the protrusion interferes with the base 11 of the housing 1, so as to realize sealing of a wire exiting side of the base 11.

It may be understood that, after the first wires 3 and the second wires 5 are provided in the housing 1, the first wires 3 and the second wires 5 are correspondingly connected to the first conductive terminals 2 and the second conductive terminals 4, connected points between the first wires 3 and the second wires 5 and the first conductive terminals 2 and the second conductive terminals 4 are positioned in the housing 1, and are positioned in a sealing space which is used to fill the sealing body 15 (for example, is used to fill a sealant in the potting space). After the sealing body 15 is potted, the sealing body 15 may be further used to seal the aforementioned connected points, so as to effectively prevent external substance, such as water and/or dust and the like, from generating poor effect on the connected points, ensure reliability and stability of electrical contact.

According to some embodiments, the present disclosure further provides an electrical connector, specifically may include a housing 1, at least two first conductive terminals 2 and at least one group of second conductive terminal 4.

The housing 1 may include a first side 1a and a second side 1b which is opposite to the first side 1a.

The first conductive terminals 2 may be inserted into the housing 1; each first conductive terminal 2 is electrically connected to at least one corresponding first wire 3.

The second conductive terminals 4 may be inserted into the housing 1; each second conductive terminal 4 in each group of second conductive terminal 4 is electrically connected to at least two corresponding second wires 5.

Wherein, each group of second conductive terminal 4 is adjacent to at least one first conductive terminal 2 in the first direction; the at least one first wire 3 which is electrically connected correspondingly to each first conductive terminal 2 exits from at least one side of the housing 1; one part of the second wires 5 which are electrically connected correspondingly to each second conductive terminal 4 exits from the first side 1a of the housing 1, the other part of the second wires 5 which are electrically connected correspondingly to each second conductive terminal 4 exits from the second side 1b of the housing 1.

The various technical features of the above embodiments can be combined in any way. In order to make the description concise, not all possible combinations of the various technical features of the above embodiments have been described. However, as long as there is no contradiction in the combination of these technical features, they should be considered within the scope of this specification.

The above embodiments only express several embodiments of the present disclosure, and their descriptions are more specific and detailed, but should not be understood as limiting the scope of the patent disclosure. It should be pointed out that, for ordinary technical personnel in this field, several variations and modification can be made without departing from the concept of the present disclosure, which are within the scope of protection of the present disclosure. Therefore, the scope of protection of the present disclosure should be based on the appended claims.

What is claimed is:

1. An electrical connector, comprising:
a housing which comprises a first side and a second side opposite to the first side;
at least two first conductive terminals which are inserted into the housing, each first conductive terminal being electrically connected to at least two corresponding first wires;
at least one group of second conductive terminal which is inserted into the housing, each second conductive terminal of each group of second conductive terminal being electrically connected to at least one corresponding second wire;
wherein
each group of second conductive terminal is adjacent to at least one first conductive terminal in a first direction;
one part of the first wires which are electrically connected correspondingly to each first conductive terminal exits from the first side of the housing, the other part of the first wires which are electrically connected correspondingly to each first conductive terminal exits from the housing of the second side;
at least one second wire which is electrically connected correspondingly to each second conductive terminal exits from at least one side of the housing.

2. The electrical connector according to claim 1, wherein
that each second conductive terminal is electrically connected to at least one corresponding second wire comprises that each second conductive terminal is electrically connected to at least two corresponding second wires;
wherein, a part of the second wires which are electrically connected correspondingly to each second conductive terminal exits from the first side of the housing, the other part of the second wires which are electrically connected correspondingly to each second conductive terminal exits from the second side of the housing.

3. The electrical connector according to claim 2, wherein
the second wires that exit from the first side of the housing form a second wire group, the second wires in the second wire group are distributed as N row(s) and m column(s), where N and M each are an integer which is larger than or equal to 1.

4. The electrical connector according to claim 1, wherein
each group of second conductive terminal is distributed as the second conductive terminals of A column(s) and B row(s), each column extends along a second direction, each row extends along the first direction, wherein the second direction intersects the first direction, A and B each are an integer which is larger than or equal to 1;
an extending width of at least one first conductive terminal in the second direction is not less than a distance between centers of any two second conductive terminals of each column of each group of second conductive terminal.

5. The electrical connector according to claim 1, wherein
the first side and the second side are long sides of the housing.

6. The electrical connector according to claim 1, wherein
the housing comprises:
a base having a top surface and a bottom surface which are opposite to each other and side surfaces which extend between the top surface and the bottom surface; and
a front mating portion which extends from the top surface of the base toward a direction away from the bottom surface.

7. The electrical connector according to claim 6, wherein
the housing further comprises:
a receiving cavity extending along a direction from the bottom surface of the base to the top surface;
the electrical connector further comprises:
a wire sealing component which is provided in the receiving cavity and is close to the top surface, the first conductive terminal and the second conductive terminal are inserted into the wire sealing component to make a part of the first conductive terminal and a part of the second conductive terminal positioned in the receiving cavity; and
a sealing body which is used to seal the receiving cavity.

8. The electrical connector according to claim 7, wherein
the wire sealing component comprises at least two cover plates, with an interval provided between the two adjacent cover plates;
the first conductive terminalis inserted into the cover plate, and each group of second conductive terminal is inserted into the interval between the two adjacent cover plates.

9. The electrical connector according to claim 6, wherein
the housing further comprises:
a sealing ring sheathing an outer periphery of a side of the front mating portion which is away from the base.

10. The electrical connector according to claim 1, wherein
the second wire is electrically connected to the second conductive terminal via a printed circuit board.

11. An electrical connector, comprising:
a housing comprising a first side and a second side which is opposite to the first side;
at least two first conductive terminals which are inserted into the housing, each first conductive terminal being electrically connected to at least one corresponding first wire;
at least one group of second conductive terminal which is inserted into the housing, each second conductive terminal of each group of second conductive terminal being electrically connected to at least two corresponding second wires;
wherein
each group of second conductive terminal is adjacent to at least one first conductive terminal in a first direction;
at least one first wire which is electrically connected correspondingly to each first conductive terminal exits from at least one side of the housing;
one part of the second wires which are electrically connected correspondingly to each second conductive terminal exits from the first side of the housing, the other part of the second wires which are electrically connected correspondingly to each second conductive terminal exits from the second side of the housing.
